(19) United States
(12) Patent Application Publication
(10) Pub. No.: US 2011/0289072 A1
(43) Pub. Date: Nov. 24, 2011

(54) SEARCH-BASED SYSTEM MANAGEMENT

(75) Inventors: YunRui SiMa, Beijing (CN); Yingtao Dong, Redmond, WA (US); Jichao Zhang, Beijing (CN)

(73) Assignee: MICROSOFT CORPORATION, Redmond, WA (US)

(21) Appl. No.: 12/786,246

(22) Filed: May 24, 2010

(51) Int. Cl. G06F 17/30

(52) U.S. Cl. 707/722; 707/769; 707/E17.014; 707/E17.005; 707/803; 707/781

(57) ABSTRACT

Search-based system management may be provided. A management interface comprising a search input element and a result list element may be displayed. A keyword may be received via the search input element and a plurality of matching configuration properties associated with the received keyword may be identified. At least one of the plurality of configuration properties associated with the received keyword may be displayed in the result list element, and each of the displayed plurality of configuration properties may comprise a selectable user interface element.

### BACKGROUND

Search-based system management is a process for providing an improved management interface experience for system administrators. In some situations, administrators may have trouble finding a feature or functionality or may desire to conduct a particular task without going through several layers of interface navigation. Conventional management consoles for complicated servers and/or applications may contain tens of thousands of configuration elements, making traditional searches for the desired element time consuming. For example, a mail server administrator may want to change a size quota for users' mailboxes. The administrator may need to spend time finding a mailbox pane, launching a property dialog, and navigating to the right property page and quota control to change the quota. Even when the administrator knows exactly where to find the control, the process may still require a lengthy user interface interaction process to get there.

Further, conventional systems do not provide administrators with any way to easily identify whether a certain feature has a configuration interface in the management console. For example, when an administrator is unable to find a certificate management interface in the console, they may be unsure whether there is actually an interface in the console that they didn't find or if it can be managed in other ways.

### SUMMARY

Search-based system management may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Search-based system management may be provided. A management interface comprising a search input element and a result list element may be displayed. A keyword may be received via the search input element and a plurality of matching configuration properties associated with the received keyword may be identified. At least one of the plurality of configuration properties associated with the received keyword may be displayed in the result list element, and each of the displayed plurality of configuration properties may comprise a selectable user interface element.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIGS. 2A-2B are simplified block diagrams of a user interface for providing search-based system management;

FIG. 3 is a simplified block diagram of a configuration dialog;

FIG. 4 is a flow chart of a method for providing search-based system management; and

FIG. 5 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Search-based system management may be provided. Consistent with embodiments of the present invention, a search box may be provided as part of a management console interface. Comparing to the standard structured navigation model, like trees or lists in conventional systems, search-based navigation may allow an administrator the flexibility of unstructured navigation. For example, an administrator may have a specific task in mind to accomplish, such as increasing the minimum length of a password. With a search-based console, it's not necessary for the administrator to navigate a conventional list to go to the right configuration interface manually. Instead, the administrator may input a keyword, such as “mini” or “password”. A matching algorithm may process a feature database to find features related to the keyword Consistent with embodiments of the invention, some configurations and/or features may be applicable to a system as a whole and/or individual or selected users. For example, a mailbox quota may comprise a configurable system default, but may also be configurable on a user by user basis.

The located features may be presented in a return list displayed within the management console. The administrator may then operate on the return list in a more intuitive way without any manual navigation. For example, by allowing the administrator to change a configuration value within the list, and/or by selecting the element to navigate to a configuration page or window, several navigation steps (e.g., “mouse clicks”) may be saved, improving the administrator's efficiency. By double clicking any result, for example, the administrator may be able to modify the desired feature user interface automatically. Consistent with embodiments of the invention, a minimal dialog box may be displayed comprising a control for editing the single selected property.

One metric that may be used to measure the intuitiveness of a tool is the time it takes to accomplish a task. User interface navigation time and the number of mouse clicks play major roles in providing a simple but functional user interface. By using a Data-Driven Infrastructure (DDI) to provide the unstructured navigation model, the management console may provide intuitive navigation with a reduced mouse click count. The DDI may extract the underlying configuration and/or business logic from the user interface code. This may separates the presentation layer from the business layer, allowing an new presentation layer to execute the same configuration logic. Additionally, the same presentation layer may be used to execute configuration logic for several different components (e.g., e-mail server, user account configuration, web server, DNS server, etc.).

DDI may be implemented, for example, using a standard .Net abstraction, the DataTable, and may bind configuration controls to columns in the table. A separate component (e.g., a data loader/handler) may populate the DataTable on demand, abstracting the data source from the DataTable. The data retrieval algorithm may be authored, for example, in XML, and may be separated from software code for presenting the data. Other programming languages may include similar structures to .Net's DataTable abstraction that may be suitable for providing a similar implementation.

The retrieved data may be indexed and displayed, and when a property is selected from the result display, the DataTable may be traced from the XML to derive the control that binds to the property and dynamically instantiates the configuration dialog on the screen. Because the end point is known, the dialog may bind to the property of interest. Furthermore, a navigation path may be displayed in the console to show the administrator how to navigate to it without searching next time.

Consistent with embodiments of the invention, users of the management console may comprise administrators of a computer, system, and/or application service associated with the management console. The users may be associated with user accounts comprising various security permissions. For example, some users may have security permissions allowing them to view all of the properties accessible through the management console, while other users may have permission to view and/or change only some of the properties. Some users may have permission to view properties without having permission to change the value. The management console may be operative to limit the display of matching properties to those the user has permission to view and/or change.

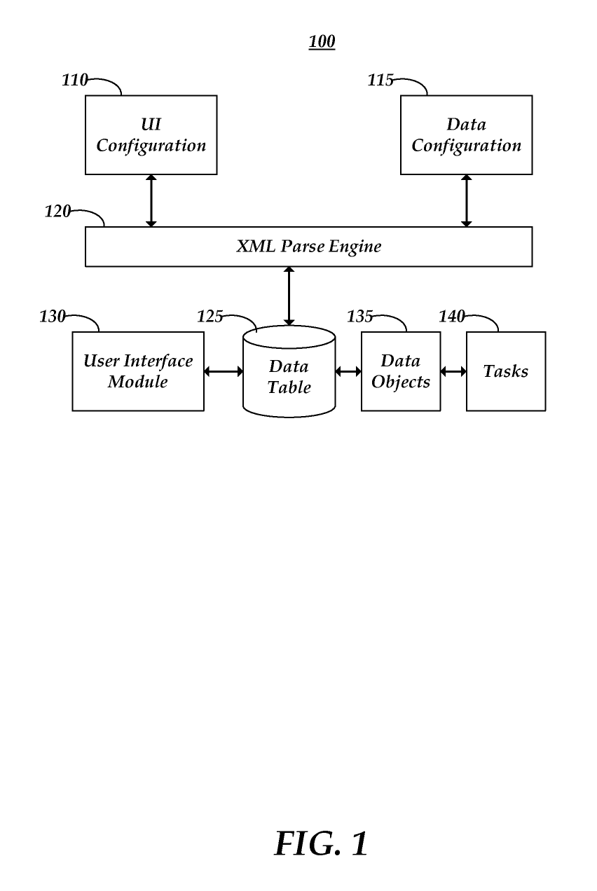

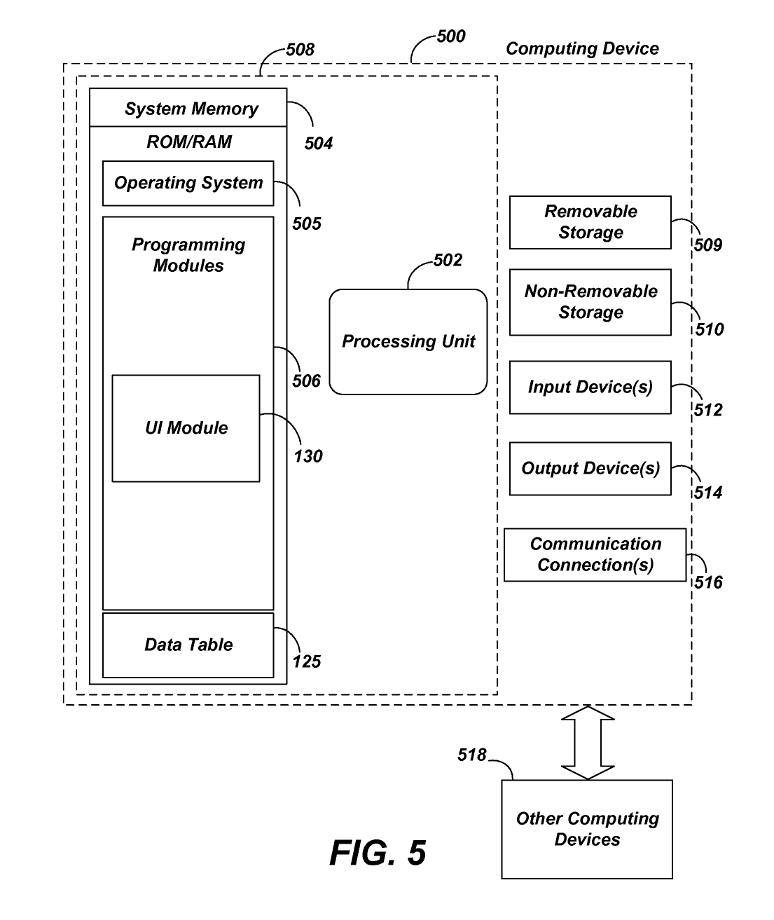

FIG. 1 is a block diagram of an operating environment 100 comprising a user interface (UI) configuration 110, a data configuration 115, an extensible markup language (XML) parse engine 120, a data table 125, a UI module 130, a plurality of data objects 135, a plurality of tasks 140. UI configuration 110 and data configuration 115 may each comprise a plurality of application and/or functional configuration information that may be stored in a table and/or file structure. For example UI configuration 110 may comprise an XML file stored on a computer such as a computing device 500, described in more detail below with respect to FIG. 5. UI configuration 110 may comprise presentation layer configuration properties such as a language, a color scheme, and/or a text size. Data configuration 115 may similarly comprise an XML file comprising a definition associated with data table 125. For example, data configuration 115 may comprise a number of columns and/or rows in data table 125. Data configuration 115 may further comprise information associated with configuration elements stored in data table 125, such as display names, sources, and/or navigation paths. Data table 125 may comprise, for example, an index of keywords and/or management elements that may be referenced when performing a search.

XML parse engine 120 may be operative to provide an abstraction between the configuration information of UI configuration 110 and/or data configuration 115 and the actual data stored in data table 125. UI module 130 may comprise executable software instructions for rendering a management console user interface, receiving interactions from a user, and/or reading and/or writing data to data table 125. Data read from data table 125 may be stored in memory structures referred to as data objects 135. These structures may comprise information such as names, types, current values, valid values, and/or descriptions for configuration properties accessible via the management console UI. Tasks 140 may comprise pending changes to one or more of data objects 135, such as a user submitted change to one of the configuration property values.

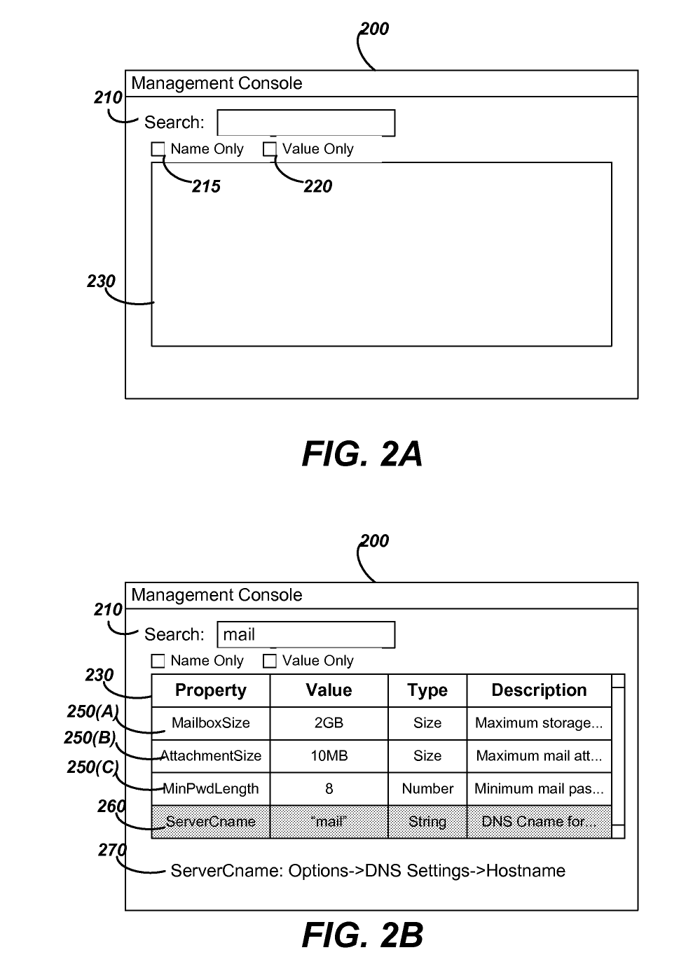

FIG. 2A is a block diagram of a search-based user interface 200 illustrating an initial display. Search-based user interface 200 may comprise a search input element 210, filtering criteria such as a name-only filtering option 215 and a value only filtering option 220, and a result list element 230. Selection of one of the filtering criteria may limit a subsequent search accordingly. For example, if neither name-only filtering option 215 nor value only filtering option 220 is selected when the search executes, the search may compare any input in search input element 210 to both names and values of available configuration properties. If name only filtering option 215 is selected, however, the search may only compare the input in search input element 210 to the names of the available configuration properties.

FIG. 2B is a block diagram of search-based user interface 200 illustrating a results display. For example, a search input in search input element 210 of “mail” may cause search-based user interface 200 to display a plurality of search results 250(A)-(C), 260, each associated with a matching configuration property. Each search result may comprise a property name, a value, a type, and/or a description. The search operation may attempt to match each of these fields associated with the configuration property and/or may be limited by one and/or more filtering criteria.

Search input element 210 may be further operative to receive multiple search terms and/or instructions, such as Boolean search terms. For example, a user may input “mail and size”, which may limit the displayed configuration properties to those that match both “mail” and “size”, such as search results 250(A)-(B). Other instructions may be operative to provide filtering criteria directly in search input element 210, such as “mail and type(number)”. This may limit the search results to those configuration properties matching the keyword “mail” and having a type of “Number”, such as search result 250(C).

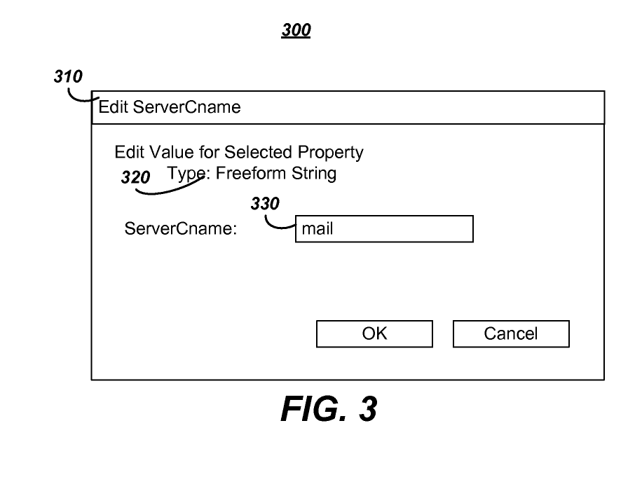

Each of search results 250(A)-(C), 260 may comprise a selectable user interface element. Selection may cause search-based user interface 200 to highlight the selected result, as illustrated by selected search result 260. A navigation path 270 may be displayed upon selection of the result comprising, for example, a menu path the user may follow to find the selected configuration property without returning to search-based user interface 200. Selection of the search result may allow the user to edit the value of the selected search result. For example, the user may be able to change the value “mail” for selected search result 260 by typing immediately after selection. For another example, a configuration dialog 300, described below with respect to FIG. 3 may be displayed for receiving the new value.

Consistent with embodiments of the invention, a search may begin as soon as a user begins typing in search input element 210, after a minimum number of characters have been entered (e.g., 3 characters), and/or after a user indicates that they have finished inputting text, such as by pressing the “Tab” or “Enter” keys on a keyboard or selecting a begin search button within search-based user interface 200 (not shown). Selection of one of the filtering criteria during and/or after a search has executed may cause any results in result list element 230 to be updated according to the newly selected criteria.

FIG. 3 is a block diagram of a configuration dialog 300. Configuration dialog 300 may comprise a title bar 310, a type display 320, and a new value input 330. The current value for selected search result 260 may be displayed in new value input 330 for modification and/or deletion. The user may enter a new value for the configuration property associated with selected search result 260 and/or may close configuration dialog 300 without making and/or saving any changes.

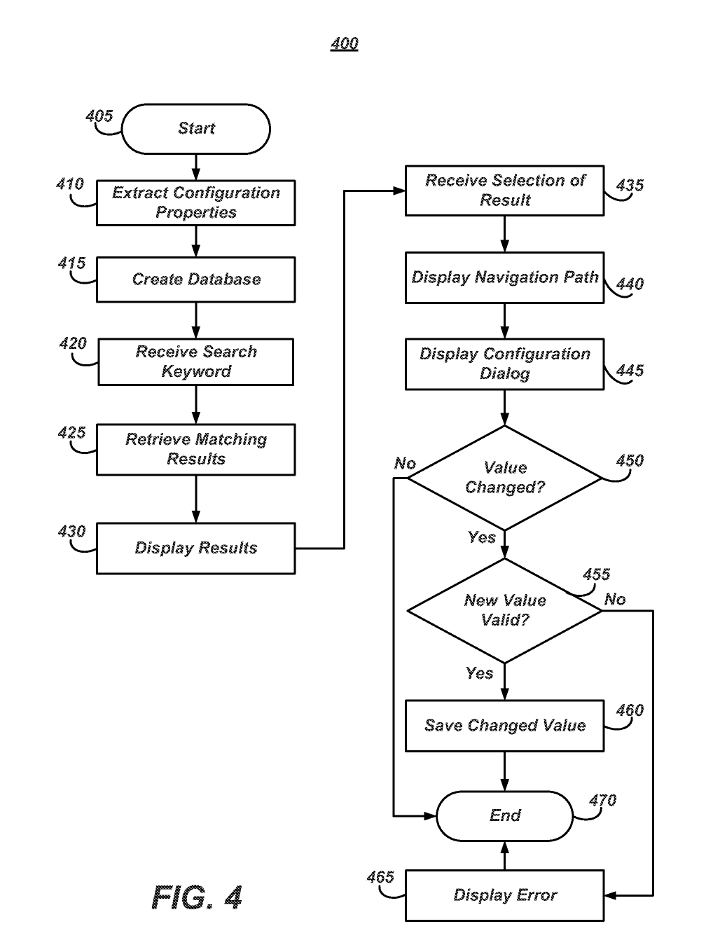

FIG. 4 is a flow chart setting forth the general stages involved in a method 400 consistent with an embodiment of the invention for providing search-based system management. Method 400 may be implemented using a computing device 500 as described in more detail below with respect to FIG. 5. Ways to implement the stages of method 400 will be described in greater detail below. Method 400 may begin at starting block 405 and proceed to stage 410 where computing device 500 may extract a plurality of configuration properties associated with at least one configurable service. For example, a service, system, and/or application may be analyzed by the DDI. The underlying software code associated with the service, system, and/or application may be read to identify any and/or all available configuration properties, their associated values, types, and/or descriptions.

Method 400 may then advance to stage 415 where computing device 500 may create a database of the extracted configuration properties. Each row in the database may comprise a property entry comprising columns such as a name, a navigation path, a description, a value, and a configuration type.

From stage 415, method 400 may advance to stage 420 where computing device 500 may receive a search keyword from an administrator of the at least one configurable service via search element within a management interface. For example, a user may type a keyword such as “mail” into search input element 210 of search-based user interface 200.

Method 400 may then advance to stage 425 where computing device 500 may retrieve a plurality of search results. For example, computing device 500 may compare the search keyword to the column entries for each configuration property row in the database. Those rows that match the keyword in at least one column may be retrieved. Consistent with embodiments of the invention, a filtering criteria may also applied to limit the search to those columns associated with the filtering criteria.

Method 400 may then advance to stage 430 where computing device 500 may display at least a portion of the plurality of search results in a result element of the management interface. For example, some and/or all of the search results retrieved at stage 425 may be displayed in result list element 230 of search-based user interface 200. The number of elements displayed may depend upon a size of search-based user interface 200. For example, search-based user interface 200 may have enough space to display four configuration properties. If four and/or fewer configuration properties match the keyword, all of them may be displayed in search-based user interface 200. If more than four configuration properties match the keyword, a first four, sorted e.g., by the property name, may be displayed and a scrollbar operative to scroll through the list may also be displayed.

Method 400 may then advance to stage 435 where computing device 500 may receive a selection of one of the displayed plurality of search results within the result element of the management interface. For example, the user may select search result 260. Search-based user interface 200 may highlight selected search result 260.

Method 400 may then advance to stage 440 where computing device 500 may display the navigation path associated with the selected one of the displayed plurality of search results within the management interface. For example, search-based user interface 200 may display navigation path 270 below result list element 230.

Method 400 may then advance to stage 445 where computing device 500 may display a configuration dialog associated with the selected search results. For example, configuration dialog 300 may be displayed and may be operative to receive a new and/or modified value according to the configuration type of the selected search results. Some configuration properties may be limited to values from a specified list of values (e.g., “enabled” or “disabled”) and the value modification element of configuration dialog 300 may be configured according to this limitation.

Method 400 may then advance to stage 450 where computing device 500 may determine whether a change to the value of the selected one of the displayed plurality of search results has been received via the configuration dialog. For example, the user may change a string value for selected search result 260 from “mail” to “webmail”. If no new value is entered, method 400 may end at stage 470.

Otherwise, if the value is determined to be changed at stage 450, method 400 may advance to stage 455 where computing device 500 may determine whether the new value is valid. For example, the value of selected search result 260 may comprise a string type that may be limited to alphanumeric characters only. Search-based user interface 200 may verify that only alphanumeric characters have been entered in new value input element 330. Consistent with embodiments of the invention, the database row for the selected configuration property may comprise a column providing valid values, such as a numeric range for a numeric type configuration value. The new value may be validated against the valid value(s) stored in the associated database column.

If the new value is determined to be valid at stage 455, method 400 may advance to stage 460 where computing device 500 may save the changed value of the selected configuration property. For example, computing device 500 may update the value column of the row associated with selected search result 260 in the database to match the new value.

Consistent with embodiments of the invention, the computing device may determine how to apply the new value. For example, the new value may be associated with a property that may be configured differently for different users. The administrator may elect to apply the changed value as a system default and/or to one and/or more users. User interface 200 may, for example, present the administrator with a dialog box listing applicable users wherein the administrator may select one, some, none, and/or all users for whom the new value may apply. Similarly, the administrator may be allowed to specify that the changed value may apply to the system as a default. Method 400 may then end at stage 470.

If the new value is determined to be invalid at stage 455, method 400 may advance to stage 465 where computing device 500 may display an error. For example, an alert message comprising an explanation of the error may be displayed. Consistent with embodiments of the invention, the alert message may further comprise an explanation of the valid values. Method 400 may then end at stage 470.

An embodiment consistent with the invention may comprise a system for providing search-based system management. The system may comprise a memory storage and a processing unit coupled to the memory storage. The processing unit may be operative to display a management interface comprising a search input element and a result list element, receive a keyword via the search input element, identify a plurality of matching configuration properties associated with the received keyword, and display at least one of the plurality of configuration properties associated with the received keyword in the result list element, wherein each of the displayed plurality of configuration properties comprises a selectable user interface element. The processing unit may be further operative to create a database comprising a plurality of rows, wherein each row is associated with at least one configuration property. The database may be created in response to receiving the search query and may comprise rows associated with configuration properties that match the received keyword in at least one element, such as a property name, a description, a value, and/or a type. Consistent with embodiments of the invention, the processing unit may be operative to create a database comprising all configuration properties associated with an application, system, and/or service and may search for matching entries within this database upon receiving the keyword. The processing unit may be further operative to receive a selection of the displayed configuration property, provide a value input user interface element associated with the selected property, receive a new value for the property, and store the new value in the row of the database associated with the selected property.

Another embodiment consistent with the invention may comprise a system for providing search-based system management. The system may comprise a memory storage and a processing unit coupled to the memory storage. The processing unit may be operative to authenticate a user, displaying a management console user interface comprising a search element and a result list element, receive a search term from the user via the search element, identify a plurality of configuration properties associated with the search term, and display at least some of the matching configuration properties associated with the received search term in the result list element. The processing unit may be further operative to receive a selection of at least one of the matching configuration properties, and display an input element associated with a value of the at least one of the matching configuration properties, receive a new value input from the user via the input element, determine whether the new value input comprises a valid value for the at least one of the matching configuration properties, and, if so, update the at least one of the matching configuration properties with the new value input.

Yet another embodiment consistent with the invention may comprise a system for providing search-based system management. The system may comprise a memory storage and a processing unit coupled to the memory storage. The processing unit may be operative to extract a plurality of configuration properties associated with at least one configurable service, create a database comprising a plurality of entries each associated with at least one of the plurality of configuration properties, wherein each entry comprises plurality of elements a name, a navigation path, a description, a value, and a configuration type, receive a search keyword from an administrator of the at least one configurable service via search element within a management interface, retrieve a plurality of search results comprising a subset of the plurality of entries from the database, wherein each of the plurality of search results comprises a match between the search keyword and at least one of the plurality of elements associated with each of the subset of the plurality of entries from the database, display at least a portion of the plurality of search results in a result element of the management interface, receive a selection of one of the displayed plurality of search results within the result element of the management interface, display the navigation path associated with the selected one of the displayed plurality of search results within the management interface, display a configuration dialog comprising the selected one of the displayed plurality of search results and a value modification user interface element according to the configuration type of the selected one of the displayed plurality of search results and comprising the value of the selected one of the displayed plurality of search results, determine whether a change to the value of the selected one of the displayed plurality of search results has been received via the configuration dialog, and, if so, save the changed value of the selected one of the displayed plurality of search results.

FIG. 5 is a block diagram of a system including computing device 500. Consistent with an embodiment of the invention, the aforementioned memory storage and processing unit may be implemented in a computing device, such as computing device 500 of FIG. 5. Any suitable combination of hardware, software, or firmware may be used to implement the memory storage and processing unit. For example, the memory storage and processing unit may be implemented with computing device 500 or any of other computing devices 518, in combination with computing device 500. The aforementioned system, device, and processors are examples and other systems, devices, and processors may comprise the aforementioned memory storage and processing unit, consistent with embodiments of the invention. Furthermore, computing device 500 may comprise an operating environment for system 100 as described above. System 100 may operate in other environments and is not limited to computing device 500.

With reference to FIG. 5, a system consistent with an embodiment of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include user interface module 130. Operating system 505, for example, may be suitable for controlling computing device 500's operation. In some embodiments, memory 504 may comprise data table 125. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computing device 500 may also contain a communication connection 516 that may allow device 500 to communicate with other computing devices 518, such as over a network in a distributed computing environment, for example, an intranet or the Internet. Communication connection 516 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g. UI module 130) may perform processes including, for example, one or more of method 400's stages as described above. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing search-based system management, the method comprising:
displaying a management interface comprising a search input element and a result list element;
receiving a keyword via the search input element;
identifying a plurality of matching configuration properties associated with the received keyword; and
displaying at least one of the plurality of configuration properties associated with the received keyword in the result list element, wherein each of the displayed plurality of configuration properties comprises a selectable user interface element.

2. The method of claim 1, further comprising creating a database comprising a plurality of rows, wherein each row is associated with at least one configuration property.

3. The method of claim 2, wherein each of the plurality of rows comprises at least one of the following: a name of the associated configuration property, a description of the associated configuration property, a value of the associated configuration property, and a type of the associated configuration property.

4. The method of claim 3, wherein identifying the plurality of matching configuration properties associated with the received keyword comprises comparing the keyword to each of the rows of the database.

5. The method of claim 4, further comprising:
receiving a selection of the displayed at least one of the plurality of configuration properties; and
providing a value input user interface element associated with the selected one of the plurality of configuration properties.

6. The method of claim 5, further comprising:
receiving a new value for the selected one of the plurality of configuration properties via the value input element; and
storing the new value in the row of the database associated with the selected one of the plurality of configuration properties.

7. The method of claim 1, wherein the received keyword comprises a text input from a user.

8. The method of claim 7, wherein each of the plurality of matching configuration properties comprises a required security permission to view and a required security permission to change an associated value.

9. The method of claim 8, further comprising:
determining whether the user is permitted to view the at least one of the plurality of matching configuration properties according to the required security permission to view of the at least one of the plurality of matching configuration properties; and
in response to determining that the user is permitted to view the at least one of the plurality of matching configuration properties, displaying at least one of the plurality of configuration properties associated with the received keyword in the result list element.

10. The method of claim 9, further comprising:
receiving a selection of the displayed at least one of the plurality of configuration properties;
determining whether the user is permitted to change the associated value of the at least one of the plurality of matching configuration properties according to the required security permission to change the associated value; and
in response to determining that the user is permitted to change the associated value of the at least one of the plurality of matching configuration properties, providing a value input user interface element associated with the selected one of the plurality of configuration properties.

11. A computer-readable medium which stores a set of instructions which when executed performs a method for providing search-based system management, the method executed by the set of instructions comprising:
authenticating a user as comprising at least one administrator security permission;
displaying a management console user interface comprising a search element and a result list element;
receiving a search term from the user via the search element;
identifying a plurality of configuration properties associated with the search term; and
displaying at least a subset of the matching configuration properties associated with the received search term in the result list element, wherein each of the matching configuration properties comprises a selectable user interface element.

12. The computer-readable medium of claim 11, wherein the search element comprises at least one filtering option.

13. The computer-readable medium of claim 12, further comprising:
receiving a selection of the at least one filtering option; and
limiting the display of matching configuration properties to a subset of the matching configuration properties associated with the at least one filtering option.

14. The computer-readable medium of claim 11, further comprising:
receiving a selection of the selectable user interface element associated with at least one of the matching configuration properties; and
displaying an input element associated with a value of the at least one of the matching configuration properties.

15. The computer-readable medium of claim 14, wherein the input element comprises an input field within the result list element.

16. The computer-readable medium of claim 14, wherein the input element comprises an input field within a dialog box window

17. The computer-readable medium of claim 14, wherein the input element is configured according to a type of the value.

18. The computer-readable medium of claim 14, further comprising:
receiving a new value input from the user via the input element; and
updating the at least one of the matching configuration properties with the new value input.

19. The computer-readable medium of claim 18, further comprising:
determining whether the new value input comprises a valid value for the at least one of the matching configuration properties; and
in response to determining that the new value input does not comprise a valid value for the at least one of the matching configuration properties, displaying an error to the user.

20. A system for providing search-based system management, the system comprising:
a memory storage; and
a processing unit coupled to the memory storage, wherein the processing unit is operative to:
extract a plurality of configuration properties associated with at least one configurable service,
create a database comprising a plurality of entries each associated with at least one of the plurality of configuration properties, wherein each entry comprises plurality of elements a name, a navigation path, a description, a value, and a configuration type,
receive a search keyword from an administrator of the at least one configurable service via search element within a management interface,
retrieve a plurality of search results comprising a subset of the plurality of entries from the database, wherein each of the plurality of search results comprises a match between the search keyword and at least one of the plurality of elements associated with each of the subset of the plurality of entries from the database,
display at least a portion of the plurality of search results in a result element of the management interface,
receive a selection of one of the displayed plurality of search results within the result element of the management interface,
display the navigation path associated with the selected one of the displayed plurality of search results within the management interface,
display a configuration dialog comprising the selected one of the displayed plurality of search results and a value modification user interface element according to the configuration type of the selected one of the displayed plurality of search results and comprising the value of the selected one of the displayed plurality of search results,
determine whether a change to the value of the selected one of the displayed plurality of search results has been received via the configuration dialog, and
in response to determining that the change to the value of the selected one of the displayed plurality of search results has been received via the configuration dialog, save the changed value of the selected one of the displayed plurality of search results.
